(19) United States
(12) Patent Application Publication
(10) Pub. No.: US 2024/0059346 A1
(43) Pub. Date: Feb. 22, 2024

(54) REDUCER OF ELECTRIC POWER STEERING DEVICE AND METHOD FOR MANUFACTURING THE SAME

(71) Applicant: HL Mando Corporation, Pyeongtaek-si (KR)

(72) Inventor: Jonghan KIM, Seongnam-si (KR)

(21) Appl. No.: 18/235,100

(22) Filed: Aug. 17, 2023

(30) Foreign Application Priority Data
Aug. 19, 2022 (KR) 10-2022-0103927
May 17, 2023 (KR) 10-2023-0063706

(51) Int. Cl. B62D 5/04; F16H 1/16; F16H 55/08

(52) U.S. Cl. CPC B62D 5/0454; B62D 5/0409; F16H 1/16; F16H 55/08; F16H 2057/0213

(57) ABSTRACT

The present embodiments provide a reducer of an electric power steering device, comprising a boss having a coupling hole formed in a central portion to allow a steering shaft to be coupled thereto and a gear portion on an outer circumferential side of the boss and having a tooth recess portion engaged with a worm on an outer circumferential surface thereof, wherein the tooth recess portion has a first end and a second end in an axial direction of the gear portion, the first end being axially opened, and the second end being closed, and a method for manufacturing the same.

### CROSS-REFERENCE TO RELATED APPLICATION

This application claims priority from Korean Patent Application Nos. 10-2022-0103927, filed on Aug. 19, 2022, and 10-2023-0063706, filed on May 17, 2023, both of which are incorporated herein by reference in their entireties.

### BACKGROUND

### Field

The present embodiments relate to a reducer of an electric power steering device and, more specifically, to a reducer of an electric power steering device which may increase power transfer rate by increasing the teeth contact rate during teeth engagement between worm and worm wheel, reduce noise with a reduced gap, reduce the manufacturing process and costs with easier processing on the tooth recess of the worm wheel, and increase the precision and mechanical durability of the worm wheel to allow the reducer to be used stably for a long time.

### Description of Related Art

In general, vehicle steering devices adopt power steering for assisting the driver in manipulating the steering wheel and providing steering convenience. Power steering as developed and adopted includes hydraulic steering devices using hydraulic power, electro-hydraulic steering devices using both hydraulic power and motor power, and electric power steering devices using only motor power.

In the conventional electric power steering device, the worm wheel is formed such that the tooth recess has openings at two opposite side ends in the axial direction to provide easier processing. However, the teeth contact rate reduces, deteriorating the power transmission rate.

Further, due to a large gap between the teeth engagement portions of the worm and worm wheel, significant vibration and noise generated during rotation may be directly delivered to the driver, and the durability of internal components of the reducer may be deteriorated, or components may be damaged.

Therefore, a need arises for increasing the durability of the reducer by decreasing vibration and noise while increasing the power transmission rate by increasing the teeth contact rate of the worm wheel in a reducer of an electric power steering device.

### BRIEF SUMMARY

Conceived in the foregoing background, the present embodiments may provide a reducer of an electric power steering device and a method for manufacturing the same, which may increase power transfer rate by increasing the teeth contact rate during teeth engagement between worm and worm wheel, reduce noise with a reduced gap, reduce the manufacturing process and costs with easier processing on the tooth recess of the worm wheel, and increase the precision and mechanical durability of the worm wheel to allow the reducer to be used stably for a long time.

The objects of embodiments of the disclosure are not limited to the foregoing and other objects will be apparent to one of ordinary skill in the art from the following detailed description.

According to the present embodiments, there may be provided a reducer of an electric power steering device, comprising a boss having a coupling hole formed in a central portion to allow a steering shaft to be coupled thereto and a gear portion on an outer circumferential side of the boss and having a tooth recess portion engaged with a worm on an outer circumferential surface thereof, wherein the tooth recess portion has a first end and a second end in an axial direction of the gear portion, the first end being axially opened, and the second end being closed.

Further, in the present embodiments, in the gear portion, the closed second end of the tooth recess portion may be larger in radial length than the opened first end of the tooth recess portion.

Further, in the present embodiments, the gear portion may include a first gear portion formed to have a constant thickness and a constant radial length in the opened first end of the tooth recess portion and a second gear portion formed to have a gradually reducing thickness and a constant radial length in the closed second end of the tooth recess portion, wherein the radial length of the second gear portion is larger than the radial length of the first gear portion.

Further, in the present embodiments, the gear portion may further include a connecting gear portion axially connecting the first gear portion and the second gear portion at a constant thickness and having a radial length increasing from the first gear portion to the second gear portion.

Further, in the present embodiments, the first gear portion may be formed to have a constant circumferential width of the tooth recess portion.

Further, in the present embodiments, the second gear portion may be formed to have a circumferential width of the tooth recess portion gradually decreasing to the second end of the gear portion.

Further, in the present embodiments, the connecting gear portion may be formed to have a constant circumferential width of the tooth recess portion.

Further, in the present embodiments, the first gear portion may be formed to have a constant depth of the tooth recess portion.

Further, in the present embodiments, the second gear portion may be formed to have a depth of the tooth recess portion gradually decreasing to the second end of the gear portion.

Further, in the present embodiments, the connecting gear portion may be formed to have a constant depth of the tooth recess portion.

Further, in the present embodiments, the second gear portion may be formed to have a curved tip in a direction toward the second end of the tooth recess portion.

Further, in the present embodiments, the boss may include a gear portion coupling portion having a spline groove in an outer circumferential surface thereof and surrounded by the gear portion, a cylindrical shaft coupling portion having the coupling hole, and an annular boss connecting portion connecting the gear portion coupling portion and the shaft coupling portion.

Further, in the present embodiments, the gear portion coupling portion and the shaft coupling portion may be formed to axially protrude beyond the boss connecting portion.

Further, in the present embodiments, the spline groove may be formed to have a constant circumferential width.

Further, in the present embodiments, the spline groove may be formed to have a constant depth.

Further, in the present embodiments, the gear portion coupling portion may have a side protrusion axially protruding.

Further, in the present embodiments, the side protrusion may be radially spaced apart from the spline groove and may be disposed between adjacent spline grooves.

Further, in the present embodiments, a key recess may be axially formed in an inner circumferential surface of the shaft coupling portion.

Further, according to the present embodiments, there may be provided a method for manufacturing a reducer of an electric power steering device, comprising a boss forming step for forming a coupling hole in a central axis to allow a steering shaft to be coupled thereto, forming a spline groove in an outer circumferential surface thereof, and forming a side protrusion axially protruding on a side surface thereof and a gear portion and tooth recess portion forming step for forming a gear portion and a tooth recess portion by injection-molding a plastic resin to allow a second end in an axial direction to be larger in radial length than a first end while surrounding the spline groove and the side protrusion on an outer circumferential side of a boss formed the boss forming step.

Further, in the present embodiments, the method may further comprise a tooth recess portion processing step for cutting an inner surface of the tooth recess portion formed in the gear portion and tooth recess portion forming step to match a contact surface of a worm.

According to the present embodiments, it is possible to increase power transfer rate by increasing the teeth contact rate during teeth engagement between worm and worm wheel and reduce noise with a reduced gap in a reducer of an electric power steering device.

It is also possible to reduce the manufacturing process and costs with easier processing on the tooth recess of the worm wheel, and increase the precision and mechanical durability of the worm wheel to allow the reducer to be used stably for a long time.

### DESCRIPTION OF DRAWINGS

The above and other objects, features, and advantages of the disclosure will be more clearly understood from the following detailed description, taken in conjunction with the accompanying drawings, in which:

FIG. 1 is a perspective view illustrating a portion of a reducer of an electric power steering device according to the present embodiments;

FIG. 2 is a front view illustrating a portion of a reducer of an electric power steering device according to the present embodiments;

FIGS. 3 and 4 are perspective views illustrating a portion of a reducer of an electric power steering device according to the present embodiments;

FIGS. 5 and 6 are side views illustrating a portion of a reducer of an electric power steering device according to the present embodiments;

FIG. 7 is a cross-sectional view of portion A-A′ of FIG. 6;

FIG. 8 is a perspective view illustrating a portion of a reducer of an electric power steering device according to the present embodiments;

FIG. 9 is a flowchart illustrating a method for manufacturing a reducer of an electric power steering device according to the present embodiments; and

FIG. 10 is a reference view illustrating a method for manufacturing a reducer of an electric power steering device according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term. “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

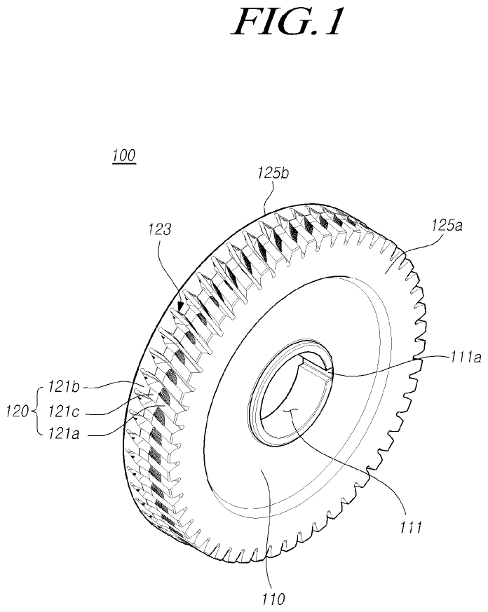

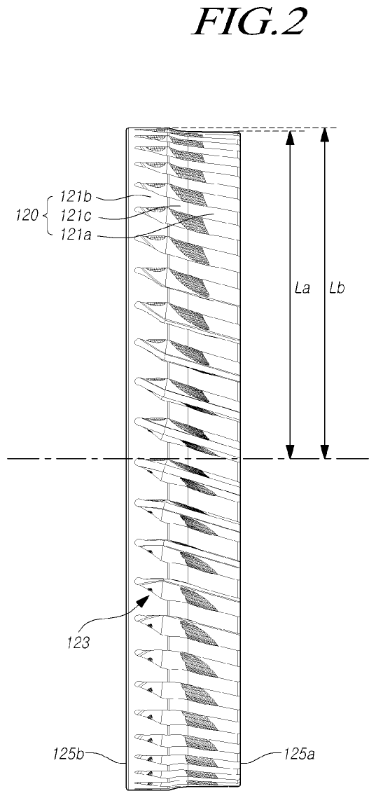

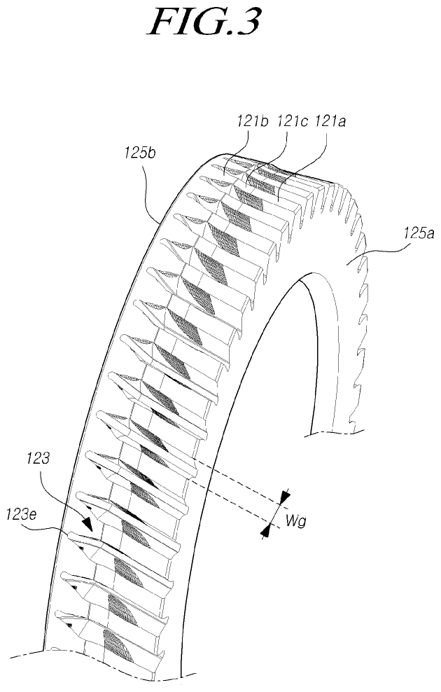

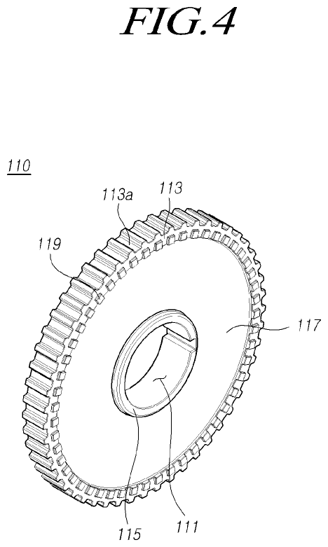

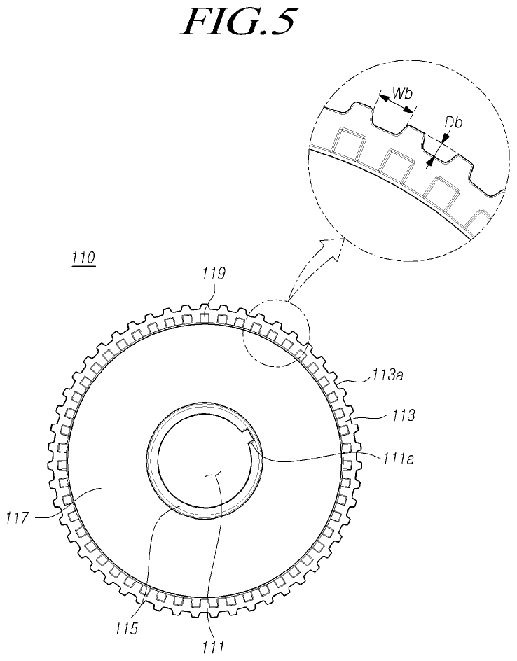

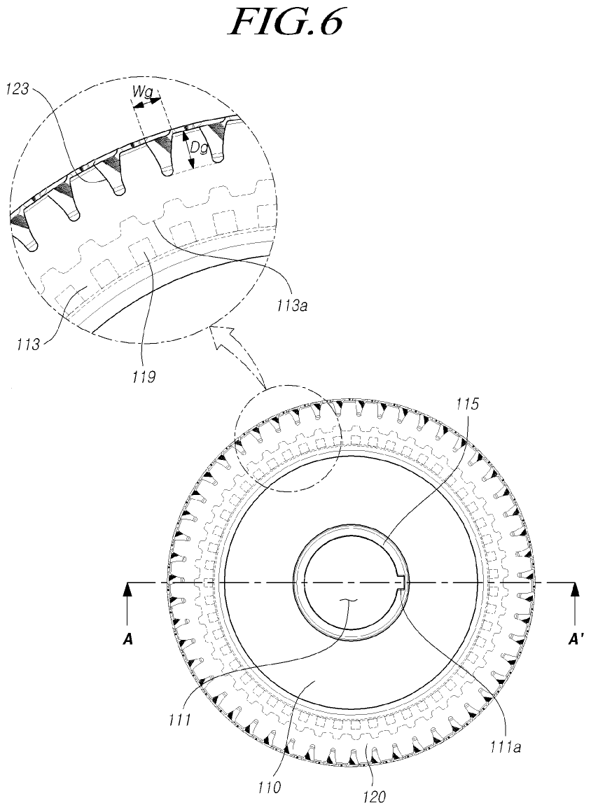

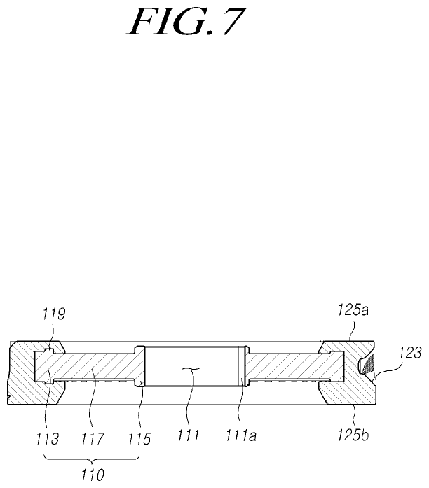

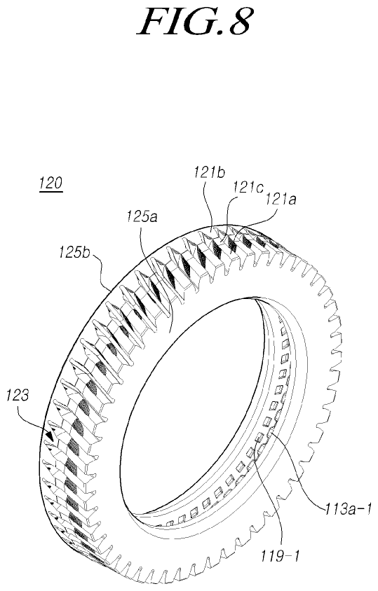

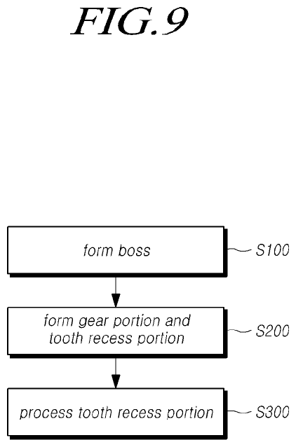

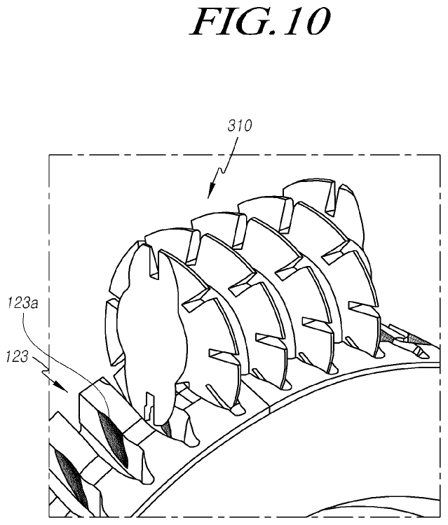

FIG. 1 is a perspective view illustrating a portion of a reducer of an electric power steering device according to the present embodiments. FIG. 2 is a front view illustrating a portion of a reducer of an electric power steering device according to the present embodiments. FIGS. 3 and 4 are perspective views illustrating a portion of a reducer of an electric power steering device according to the present embodiments. FIGS. 5 and 6 are side views illustrating a portion of a reducer of an electric power steering device according to the present embodiments. FIG. 7 is a cross-sectional view of portion A-A′ of FIG. 6. FIG. 8 is a perspective view illustrating a portion of a reducer of an electric power steering device according to the present embodiments. FIG. 9 is a flowchart illustrating a method for manufacturing a reducer of an electric power steering device according to the present embodiments. FIG. 10 is a reference view illustrating a method for manufacturing a reducer of an electric power steering device according to the present embodiments.

As shown in the drawings, a reducer of an electric power steering device according to the present embodiments includes a boss 110 having a coupling hole 111 formed in a central portion to allow a steering shaft to be coupled thereto and a gear portion 120 on an outer circumferential side of the boss 110 and having a tooth recess portion 120 engaged with a worm on an outer circumferential surface thereof. The tooth recess portion 123 has a first end 125a and a second end 125b in an axial direction of the gear portion 120. The first end is axially opened, and the second end is closed.

The reducer of the electric power steering device according to the present embodiments assists the driver in manipulation by rotating the steering shaft while reducing at the gear ratio between the worm and the worm wheel 100 rotated by the driving power of a motor.

The reducer is mounted in the electric power steering device. The worm and the worm wheel 100 are interlocked to rotate the steering shaft by the motor driving power, assisting the driver in steering. While the motor runs, worm shaft bearings are fastened to two opposite ends of the worm interlocked with the shaft of the motor, supporting rotation of the worm. The worm wheel 100 and the worm interlocked with the steering shaft are placed inside the gear housing.

The steering shaft, which transfers the rotational force of the steering wheel when the driver manipulates the steering wheel to the rack bar, is connected from the steering wheel through the column and universal joint to the gear box having the rack gear and the pinion, and the reducer may be coupled to the pinion shaft or steering shaft mounted in the gear box and column.

Accordingly, if the worm is rotated by the driving of the motor, the worm wheel 100 is rotated in conjunction therewith and, at this time, the worm wheel 100 is coupled to the steering shaft of the steering column or the steering shaft of the gear box to assist the driver's steering force.

The worm wheel 100 includes a boss 110 and a gear portion 120. The gear portion 120 is formed on the outer circumferential portion of the boss 110 by injection molding. The gear portion 120 has tooth recess portions 123 engaged with the worm on the outer circumferential surface thereof.

The first end 125a, in the axial direction of the gear portion 120, of the tooth recess portion 123 is axially opened, and the second end 125b in the axial direction of the gear portion 120 is closed.

The gear portion 120 is formed so that the radial lengths of the first end 125a and the second end 125b in the axial direction differ from each other to increase the rigidity of the gear portion 120.

In other words, as shown in FIG. 2, the radial length Lb of the closed second end 125b in the tooth recess portion 123 is formed to be larger than the radial length La of the opened first end 125a of the tooth recess portion 123, thereby reinforcing the tip rigidity of the tooth recess portion 123 when the tip of the tooth recess portion 123 is forced to widen by the supporting force of the worm engaged to the tooth recess portion 123.

Worm supporting surfaces 123a are formed on two opposite inner surfaces of the tooth recess portion 123 to have the same tooth shape as that of the worm. The worm supporting surface 123a is formed by a burnishing tool which is a cutting tool having the same tooth shape as that of the worm.

Accordingly, when the tooth recess portion 123 contacts the worm, the contact area increases, allowing the supporting force of the worm to be uniformly transferred, and the rigidity of the tooth recess portion 123 which withstands the bending stress and shear stress generated at the tooth recess portion 123 is maintained, preventing deformation and damage.

The gear portion 120 includes a first gear portion 121a having a constant thickness and a constant radial length in the first end 125a where the tooth recess portion 123 is opened and a second gear portion 121b having a gradually reducing thickness and a constant radial length, which is larger than the radial length of the first gear portion 121a, in the second end 125b where the tooth recess portion 123 is closed.

Further, the gear portion 120 may further include a connecting gear portion 121c connecting the first gear portion 121a and the second gear portion 121b while having a constant thickness and increasing in radial length from the first gear portion 121a to the second gear portion 121b.

As shown in FIG. 3, the first gear portion 121a is formed so that the circumferential width Wg of the tooth recess portion 123 is constant, the second gear portion 121b is formed so that the circumferential width Wg of the tooth recess portion 123 gradually reduces toward the second end 125b of the gear portion 120, and the connecting gear portion 121c is formed so that the circumferential width Wg of the tooth recess portion 123 is constant.

Accordingly, the supporting force of the worm engaged with the connecting gear portion 121c and the first gear portion 121a may be constantly transferred, and deformation and damage of the tooth recess portion 123 are prevented by the rigidity of the second gear portion 121b.

Further, the first gear portion 121a is formed so that the depth Dg of the tooth recess portion 123 is constant, the second gear portion 121b is formed so that the depth Dg of the tooth recess portion 123 gradually reduces toward the second end 125b of the gear portion 120, and the connecting gear portion 121c is formed so that the depth Dg of the tooth recess portion 123 is constant.

Therefore, the worm engaged with the first gear portion 121a and the connecting gear portion 121c is engaged at the same depth, so that a constant force may be transferred to the first gear portion 121a and the connecting gear portion 121c.

As shown in FIG. 3, the second gear portion 121b is formed so that a tip 123e thereof in the direction toward the second end 125b of the tooth recess portion 123 is curved. Thus, as described above, when the tip 123e of the tooth recess portion 123 is forced to widen, concentration of the stress on the tip 123e of the tooth recess portion 123 is prevented by the supporting force of the worm as described above, thereby preventing the tip 123e of the tooth recess portion 123 from being broken.

The boss 110 has spline grooves 113a formed in the outer circumferential surface thereof and includes a gear portion coupling portion 113 surrounded by the gear portion 120, a cylindrical shaft coupling portion 115 having a coupling hole 111, and an annular boss connecting portion 117 connecting the gear portion coupling portion 113 and the shaft coupling portion 115.

The spline groove 113a is spaced apart from the tooth recess portion 123 of the gear portion 120 in the radial direction, is formed between adjacent tooth recess portions 123 in the circumferential direction, and is embedded while being surrounded by the gear portion 120 during injection molding of the gear portion 120.

The gear portion coupling portion 113 and the shaft coupling portion 115 are formed to axially protrude beyond the boss connecting portion 117, and are formed to be larger in axial thickness than the boss connecting portion 117.

This increases the rigidity of the gear portion 120 and the gear portion coupling portion 113 which are forced by the worm while increasing the rigidity of the shaft coupling portion 115 delivering force to the steering shaft, thereby preventing the overall boss 110 from deformation and damage.

The spline groove 113a is formed to have a constant circumferential width Wb from the first end 125a to second end 125b in the axial direction of the boss 110 and a constant depth.

Accordingly, the coupling strength with the spline protrusions 113a-1 which are formed on the inner circumferential surface of the gear portion 120 during injection molding of the gear portion 120 may be maintained constant. Thus, the coupling strength and supporting force between the boss 110 and the gear portion 120 may be increased, and the resin may flow better between the spline protrusions 113a-1 inside the gear portion 120 and the spline grooves 113a, allowing the gear portion 120 to overall have uniform physical properties.

Further, the gear portion coupling portion 113 has side protrusions 119 axially protruding. The side protrusion 119 is radially spaced apart from the spline groove 113a and is disposed between adjacent spline grooves 113a.

Therefore, the coupling strength with the protrusion supporting recess 119-1 formed inside the gear portion may be maintained constant in the circumferential direction, thereby increasing the coupling strength between the tooth recess portion 123 and the spline groove 113a while increasing the coupling strength between the gear portion 120 and the gear portion coupling portion 113.

Meanwhile, a key recess 111a is axially formed in the inner circumferential surface of the shaft coupling portion 115 so that during injection molding of the gear portion 120, the spline groove 113a and the tooth recess portion 123 are matched in phase in rotational direction, and the gear portion 120 is injection-molded, allowing the gear portion 120 and the boss 110 to be formed in place.

A method for manufacturing a reducer of an electric power steering device according to the present embodiments includes a boss forming step S100 for forming a coupling hole 111 in a central axis to allow a steering shaft to be coupled thereto, forming a spline groove 113a in an outer circumferential surface thereof, and forming a side protrusion 119 axially protruding on a side surface thereof and a gear portion and tooth recess portion forming step S200 for forming a gear portion 120 and a tooth recess portion 123 by injection-molding a plastic resin to allow a second end 126b in an axial direction to be larger in radial length than a first end 125a while surrounding the spline groove 113a and the side protrusion 119 on an outer circumferential side of a boss 110 formed the boss forming step S100.

The boss 110 is formed of a metal material, such as steel, and has the coupling hole 111 in the central axis to allow the steering shaft to be coupled thereto. The boss 110 has the spline groove 113a formed in the outer circumferential surface and the side protrusion formed on a side surface, and the gear portion 120 and the tooth recess portion 123 are injection-molded.

As shown in FIG. 10, the method further includes a tooth recess portion processing step S300 for cutting an inner circumferential surface of the tooth recess portion 123 formed in the gear portion and tooth recess portion forming step S200 to match the contact surface of the worm by a cutting tool 310.

As the cutting tool 310, a burnishing tool formed to match the tooth shape of the worm, rather than a bobbing tool used for manufacturing the worm wheel, is used to form the worm supporting surface 123a that has the same curved surface as the contact surface of the worm on the inner surface of the tooth recess portion 123.

Accordingly, during contact to the worm, the contact area increases, allowing the supporting force of the worm to be constantly transferred, thereby increasing the power transmission efficiency, maintaining the rigidity of the tooth recess portion 123, and preventing deformation and damage to the tooth recess portion 123.

The metallic boss 110 which is formed in a hollow shape, such as a ring, allows the steering shaft to be penetrated and coupled through the central portion thereof, and the gear portion 120 is formed by injection molding polyamide resin which is reinforced by mixing with glass fibers.

Here, the polyamide resin for injection molding the gear portion 120 and the tooth recess portion 123 is one of polyamide 6, polyamide 66, polyamide 46, and polyamide 12 and is mixed with 30 to 50 weight % of glass fiber. Thus, as compared with when manufactured only with polyamide resin, it may have enhanced hardness, tensile strength, elongation, flexural strength, and high-temperature properties and excellent frictional properties and durability.

As described above, according to the present embodiments, it is possible to increase power transfer rate by increasing the teeth contact rate during teeth engagement between worm and worm wheel and reduce noise with a reduced gap in a reducer of an electric power steering device.

It is also possible to reduce the manufacturing process and costs with easier processing on the tooth recess of the worm wheel, and increase the precision and mechanical durability of the worm wheel to allow the reducer to be used stably for a long time.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A reducer of an electric power steering device, comprising:
a boss having a coupling hole formed in a central portion to allow a steering shaft to be coupled thereto; and
a gear portion on an outer circumferential side of the boss and having a tooth recess portion engaged with a worm on an outer circumferential surface thereof,
wherein the tooth recess portion has a first end and a second end in an axial direction of the gear portion, the first end being axially opened, and the second end being closed.

2. The reducer of claim 1, wherein in the gear portion, the closed second end of the tooth recess portion is larger in radial length than the opened first end of the tooth recess portion.

3. The reducer of claim 2, wherein the gear portion includes:
a first gear portion formed to have a constant thickness and a constant radial length in the opened first end of the tooth recess portion; and
a second gear portion formed to have a gradually reducing thickness and a constant radial length in the closed second end of the tooth recess portion, wherein the radial length of the second gear portion is larger than the radial length of the first gear portion.

4. The reducer of claim 3, wherein the gear portion further includes a connecting gear portion axially connecting the first gear portion and the second gear portion at a constant thickness and having a radial length increasing from the first gear portion to the second gear portion.

5. The reducer of claim 4, wherein the first gear portion is formed to have a constant circumferential width of the tooth recess portion.

6. The reducer of claim 4, wherein the second gear portion is formed to have a circumferential width of the tooth recess portion gradually decreasing to the second end of the gear portion.

7. The reducer of claim 4, wherein the connecting gear portion is formed to have a constant circumferential width of the tooth recess portion.

8. The reducer of claim 4, wherein the first gear portion is formed to have a constant depth of the tooth recess portion.

9. The reducer of claim 4, wherein the second gear portion is formed to have a depth of the tooth recess portion gradually decreasing to the second end of the gear portion.

10. The reducer of claim 4, wherein the connecting gear portion is formed to have a constant depth of the tooth recess portion.

11. The reducer of claim 9, wherein the second gear portion is formed to have a curved tip in a direction toward the second end of the tooth recess portion.

12. The reducer of claim 1, wherein the boss includes:
a gear portion coupling portion having a spline groove in an outer circumferential surface thereof and surrounded by the gear portion;
a cylindrical shaft coupling portion having the coupling hole; and
an annular boss connecting portion connecting the gear portion coupling portion and the shaft coupling portion.

13. The reducer of claim 12, wherein the gear portion coupling portion and the shaft coupling portion are formed to axially protrude beyond the boss connecting portion.

14. The reducer of claim 12, wherein the spline groove is formed to have a constant circumferential width.

15. The reducer of claim 12, wherein the spline groove is formed to have a constant depth.

16. The reducer of claim 12, wherein the gear portion coupling portion has a side protrusion axially protruding.

17. The reducer of claim 16, wherein the side protrusion is radially spaced apart from the spline groove and is disposed between adjacent spline grooves.

18. The reducer of claim 12, wherein a key recess is axially formed in an inner circumferential surface of the shaft coupling portion.

19. A method for manufacturing a reducer of an electric power steering device, the method comprising:
a boss forming step for forming a coupling hole in a central axis to allow a steering shaft to be coupled thereto, forming a spline groove in an outer circumferential surface thereof, and forming a side protrusion axially protruding on a side surface thereof; and
a gear portion and tooth recess portion forming step for forming a gear portion and a tooth recess portion by injection-molding a plastic resin to allow a second end in an axial direction to be larger in radial length than a first end while surrounding the spline groove and the side protrusion on an outer circumferential side of a boss formed the boss forming step.

20. The method of claim 19, further comprising a tooth recess portion processing step for cutting an inner surface of the tooth recess portion formed in the gear portion and tooth recess portion forming step to match a contact surface of a worm.
